(19) United States
(12) Patent Application Publication
(10) Pub. No.: US 2026/0021776 A1
(43) Pub. Date: Jan. 22, 2026

(54) LIVING HINGE DOGHOUSE STRUCTURE FOR VEHICLE TRIM

(71) Applicant: GM GLOBAL TECHNOLOGY OPERATIONS LLC, DETROIT, MI (US)

(72) Inventors: Kyle Edwin Waid, Sterling Heights, MI (US); Glenn M. Henige, Lake Orion, MI (US); Jason Boston, St Clair Shores, MI (US)

(21) Appl. No.: 18/775,273

(22) Filed: Jul. 17, 2024

(51) Int. Cl. B60R 13/02

(52) U.S. Cl. CPC B60R 13/02; B60R 13/0206; B60R 2013/0293

(57) ABSTRACT

A trim assembly of a vehicle includes a trim panel and a doghouse structure connected to the trim panel via a hinge. The doghouse structure is movable about the hinge from a molded position to an assembled position. The doghouse structure includes a base positioned at the trim panel when in the assembled position and a cap spaced apart from the base and receivable of a fastener. A plurality of ribs protrude from the trim panel and engaged with the base to locate and secure the doghouse structure relative to the trim panel in the assembled position.

### INTRODUCTION

The subject disclosure relates to vehicles, and more particularly to installation of trim pieces to vehicle structures.

Vehicle trim components are typically molded plastic articles and are secured to a vehicle body panel by fasteners such as, for example, clips, screws or the like. Structures often referred to as “doghouses” are formed on the trim component to receive the fasteners. The clips are installed to the doghouses prior to the trim component and clip assembly then being installed to the body panel.

The doghouse structures typically protrude from a back side of the trim component, and are formed in the molding process using a slide or other secondary component of the mold. Use of the secondary components of the molds to form these structures greatly increases complexity of the mold.

### SUMMARY

In one exemplary embodiment, a trim assembly of a vehicle includes a trim panel and a doghouse structure connected to the trim panel via a hinge. The doghouse structure is movable about the hinge from a molded position to an assembled position. The doghouse structure includes a base positioned at the trim panel when in the assembled position and a cap spaced apart from the base and receivable of a fastener. A plurality of ribs protrude from the trim panel and engaged with the base to locate and secure the doghouse structure relative to the trim panel in the assembled position.

In addition to one or more of the features described herein, at least one rib of the plurality of the plurality of ribs engage with at least one base slot defined in the base.

In addition to one or more of the features described herein, at least one rib of the plurality of ribs engage with a lateral end of the base.

In addition to one or more of the features described herein, at least two ribs of the plurality of ribs engage opposing lateral ends of the base.

In addition to one or more of the features described herein, a locking rib is positioned at the trim panel extending parallel to a hinge axis of the hinge. A locking channel is positioned at the doghouse structure and is engagable with the locking rib.

In addition to one or more of the features described herein, the doghouse structure is formed with the trim panel as a single unitary component.

In addition to one or more of the features described herein, the fastener is installed into an opening in the cap.

In another exemplary embodiment, a vehicle includes a vehicle body, and a trim assembly installed to the vehicle body. The trim assembly includes a trim panel, and a doghouse structure connected to the trim panel via a hinge. The doghouse structure is movable about the hinge from a molded position to an assembled position. The doghouse structure includes a base positioned at the trim panel when in the assembled position, and a cap spaced apart from the base and receivable of a fastener. A plurality of ribs protrude from the trim panel and engage with the base to locate and secure the doghouse structure relative to the trim panel in the assembled position. A fastener is installed in the cap and is engaged with a corresponding fastener opening in the vehicle body.

In addition to one or more of the features described herein, at least one rib of the plurality of the plurality of ribs engage with at least one base slot defined in the base.

In addition to one or more of the features described herein, at least one rib of the plurality of ribs engage with a lateral end of the base.

In addition to one or more of the features described herein, at least two ribs of the plurality of ribs engage opposing lateral ends of the base.

In addition to one or more of the features described herein, a locking rib is positioned at the trim panel and extends parallel to a hinge axis of the hinge. A locking channel is positioned at the doghouse structure and is engagable with the locking rib.

In addition to one or more of the features described herein, the doghouse structure is formed with the trim panel as a single unitary component.

In addition to one or more of the features described herein, the fastener is installed in a trim fastener opening in the cap.

In yet another exemplary embodiment, a method of installing a trim assembly to a vehicle includes forming a trim assembly including a trim panel, and a doghouse structure formed integrally with the trim panel as a unitary component. The doghouse structure includes a base positioned at the trim panel when in an assembled position, and a cap spaced apart from the base and receivable of a fastener. The doghouse structure is moved about a hinge defined between the trim panel and the doghouse structure from a molded position toward an assembled position. The base is engaged with a plurality of ribs protruding from the trim panel to position the doghouse structure relative to the trim panel and retain the doghouse structure in the assembled position.

In addition to one or more of the features described herein, a fastener is installed into the cap.

In addition to one or more of the features described herein, the fastener is installed into a body opening in the vehicle to secure the trim assembly to the vehicle.

In addition to one or more of the features described herein, at least one rib of the plurality of the plurality of ribs engage with at least one base slot defined in the base.

In addition to one or more of the features described herein, at least one rib of the plurality of ribs engage with a lateral end of the base.

In addition to one or more of the features described herein, at least two ribs of the plurality of ribs engage opposing lateral ends of the base.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a perspective view of an embodiment of a vehicle;

FIG. 2 is a perspective view of an embodiment of a trim assembly of a vehicle;

FIG. 3 is a perspective view of an embodiment of a doghouse structure of a trim assembly;

FIG. 4 is a perspective view of an embodiment of a doghouse structure in a molded position; and

FIG. 5 is a perspective view of an embodiment of a doghouse structure in an assembled position.

### DETAILED DESCRIPTION

The following description is merely exemplary in nature and is not intended to limit the present disclosure, its application or uses. It should be understood that throughout the drawings, corresponding reference numerals indicate like or corresponding parts and features.

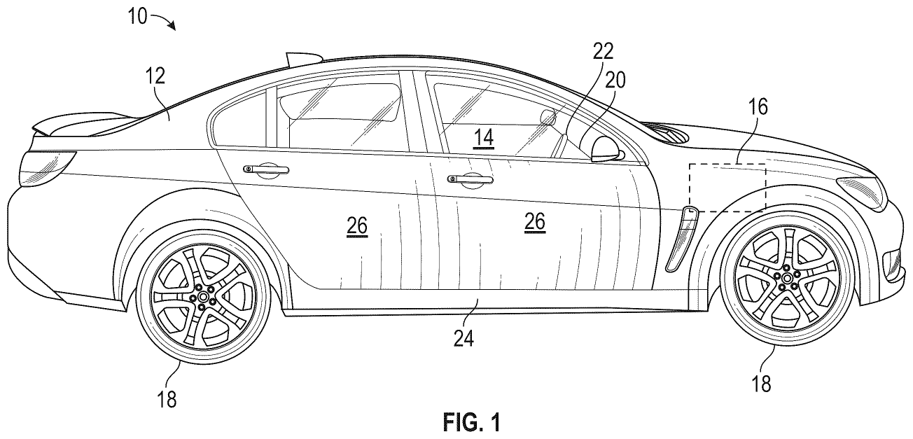

In accordance with an exemplary embodiment, illustrated in FIG. 1 is an embodiment of a vehicle 10. The vehicle 10 includes a vehicle body 12 defining a passenger compartment 14. The vehicle 10 further includes a powertrain 16 providing energy for propulsion and electrical power for operation of the vehicle systems. A plurality of wheels 18 are operably connected to the powertrain 16, and at least two of the wheels 18 are steerable. An instrument panel 20 is located in the passenger compartment 14, and a steering assembly 22 extends from the instrument panel 20 into the passenger compartment 14. The vehicle 10 further includes one or more trim components installed to the vehicle body 12, for example, one or more rocker moldings 24 installed to an exterior of the vehicle body 12, below passenger doors 26 of the vehicle 10. While the present description and figures relate to rocker moldings 24 of the vehicle 10, one skilled in the art will readily appreciate that the present disclosure may be readily applied to other exterior and interior trim components of the vehicle 10.

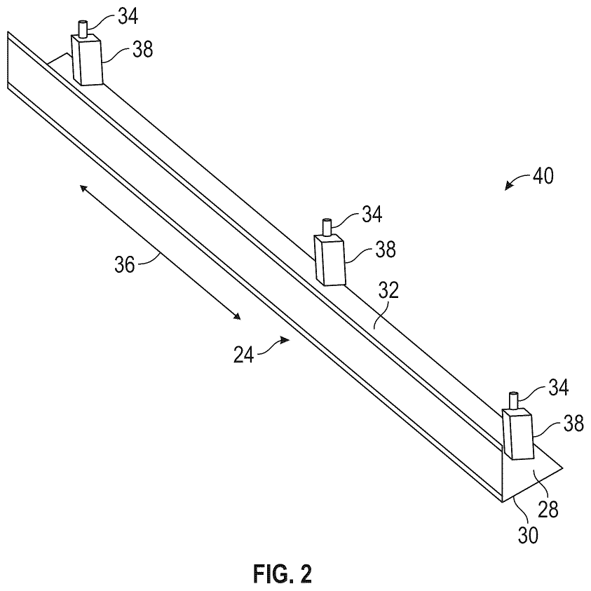

Referring now to FIG. 2, the rocker molding 24 includes a panel 28 having a first molding side 30 at least partially defining an exterior surface of the vehicle 10 and a second molding side 32 opposite the first molding side 30. A plurality of fasteners, for example, clips 34 are arrayed along a molding length 36 of the rocker molding 24. The clips 34 are configured to be installed into complimentary body openings (not shown) in the vehicle body 12 to secure the rocker molding 24 to the vehicle body 12.

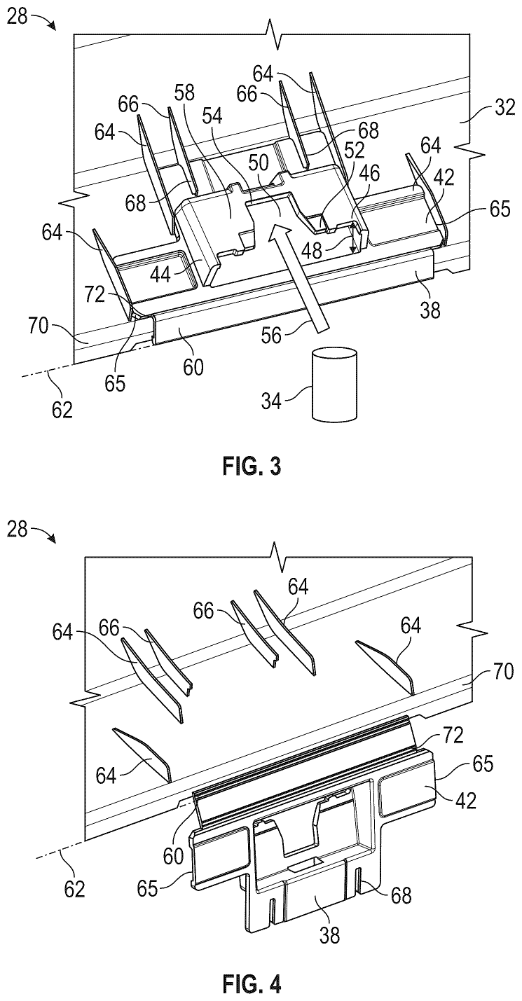

The clips 34 are each retained in a doghouse structure 38 secured at the second molding side 32 of the panel 28 to define a rocker molding assembly 40 for installation to the vehicle body 12. The doghouse structure 38 will be described in greater detail with reference to FIGS. 3-5. In an installed position, as illustrated in FIG. 3, the doghouse structure 38 includes a base 42 located at the second molding side 32, and sidewalls 44 extending from the base 42 and away from the second molding side 32. A cap 46 is located at a distal end of the sidewalls 44 at a selected height 48 from the base 42. The cap 46 includes an opening 50 configured for installation of a clip 34 thereinto. In the embodiment illustrated, the opening 50 is U-shaped, with an open end 52 at a first end of the cap 46 and a closed end 54 opposite the open end 52. The clip 34 is installable into the opening 50 in an installation direction 56 from the open end 52 toward the closed end 54. In some embodiments, the cap 46 includes one or more retention features, such as protrusions 58 (shown in FIG. 3) or localized narrowing of the opening 50 to retain the clip 34 in the opening 50 via, for example, a frictional fit. While a U-shaped opening 50 is illustrated and described herein, other embodiments may include other opening 50 shapes, such as circular opening 50 shapes.

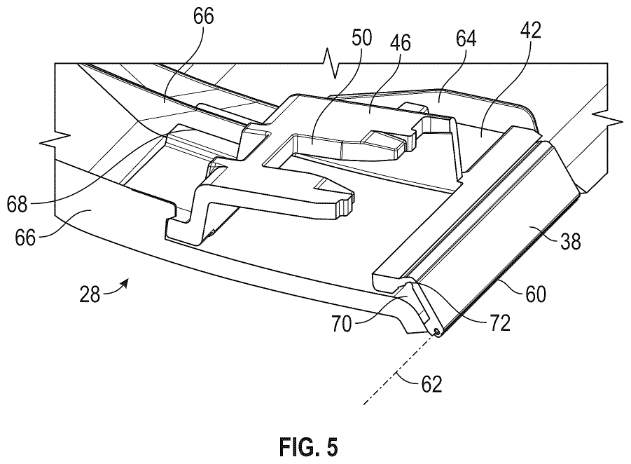

The doghouse structure 38 is formed together as a unitary article with the panel 28 and is connected thereto via a hinge 60, formed unitarily with the panel and the doghouse structure. The rocker molding 24, including the panel 28, the doghouse structure 38 and the hinge 60 are formed together via, for example, injection molding. The doghouse structure 38 is illustrated in an as-molded condition in FIG. 4. Once molded, the doghouse structure 38 is moved to an assembled condition, as illustrated in FIGS. 3 and 5. To do so, the doghouse structure 38 is moved about a hinge axis 62 of the hinge 60. The panel 28 and the doghouse structure 38 include features to locate and secure the doghouse structure 38 to the panel 28 in the assembled condition.

A plurality of locating ribs 64 are formed in the panel 28 and protrude from the second panel side 32. At least two of the locating ribs 64 are located at opposing lateral base ends 65 of the base 42. When the doghouse structure 38 is rotated about the hinge axis 62, the base ends 65 are positioned between the locating ribs 64 to correctly located the doghouse structure 38 on the second panel side 32. Additionally, one or more mid-base ribs 66 may be formed on the second panel side 32, and when the doghouse structure 38 is moved to the assembled position, the mid-base ribs 66 are received in complimentary base slots 68 to aid in positioning the doghouse structure 38 and in some embodiments to secure the doghouse structure 38 in the assembled position. Further, in some embodiments the panel 28 may include a lateral locking rib 70 that extends along the second panel side 32 parallel to the hinge axis 62. The doghouse structure 38 includes a complimentary locking channel 72 that engages the lateral locking rib 70 to lock the doghouse structure 38 into the assembled position, such as shown in FIG. 5.

The doghouse structure 38 and hinge 60 disclosed herein allow for the doghouse structure 38 to be formed via the core-cavity structure of a molding tool, without the need for complex and costly sliding core tooling. Further, the rib structures align and secure the doghouse structure 38 in place for installation to the vehicle body 12.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The term “about” is intended to include the degree of error associated with measurement of the particular quantity based upon the equipment available at the time of filing the application. For example, “about” can include a range of ±8% of a given value.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A trim assembly of a vehicle, comprising:
a trim panel;
a doghouse structure connected to the trim panel via a hinge, the doghouse structure movable about the hinge from a molded position to an assembled position, the doghouse structure including:
a base disposed at the trim panel when in the assembled position; and
a cap spaced apart from the base and receivable of a fastener; and
a plurality of ribs protruding from the trim panel and engaged with the base to locate and secure the doghouse structure relative to the trim panel in the assembled position.

2. The trim assembly of claim 1, wherein at least one rib of the plurality of the plurality of ribs engage with at least one base slot defined in the base.

3. The trim assembly of claim 1, wherein at least one rib of the plurality of ribs engage with a lateral end of the base.

4. The trim assembly of claim 3, wherein at least two ribs of the plurality of ribs engage opposing lateral ends of the base.

5. The trim assembly of claim 1, further comprising:
a locking rib disposed at the trim panel extending parallel to a hinge axis of the hinge; and
a locking channel disposed at the doghouse structure engagable with the locking rib.

6. The trim assembly of claim 1, wherein the doghouse structure is formed with the trim panel as a single unitary component.

7. The trim assembly of claim 1, further comprising a fastener opening in the cap into which the fastener is installed.

8. A vehicle, comprising:
a vehicle body;
a trim assembly installed to the vehicle body, the trim assembly including:
a trim panel;
a doghouse structure connected to the trim panel via a hinge, the doghouse structure movable about the hinge from a molded position to an assembled position, the doghouse structure including:
a base disposed at the trim panel when in the assembled position; and
a cap spaced apart from the base and receivable of a fastener;
a plurality of ribs protruding from the trim panel and engaged with the base to locate and secure the doghouse structure relative to the trim panel in the assembled position; and
a fastener installed in the cap engaged with a corresponding fastener opening in the vehicle body.

9. The vehicle of claim 8, wherein at least one rib of the plurality of the plurality of ribs engage with at least one base slot defined in the base.

10. The vehicle of claim 8, wherein at least one rib of the plurality of ribs engage with a lateral end of the base.

11. The vehicle of claim 10, wherein at least two ribs of the plurality of ribs engage opposing lateral ends of the base.

12. The vehicle of claim 8, further comprising:
a locking rib disposed at the trim panel extending parallel to a hinge axis of the hinge; and
a locking channel disposed at the doghouse structure engagable with the locking ring.

13. The vehicle of claim 8, wherein the doghouse structure is formed with the trim panel as a single unitary component.

14. The vehicle of claim 8, further comprising a trim fastener opening in the cap into which the fastener is installed.

15. A method of installing a vehicle trim assembly to a vehicle comprising:
forming a vehicle trim assembly including:
a vehicle trim panel; and
a doghouse structure formed integrally with the vehicle trim panel as a unitary component, the doghouse structure including:
a base disposed at the vehicle trim panel when in an assembled position; and
a cap spaced apart from the base and receivable of a fastener;
moving the doghouse structure about a hinge defined between the vehicle trim panel and the doghouse structure from a molded position toward an assembled position;
engaging the base with a plurality of ribs protruding from the vehicle trim panel to position the doghouse structure relative to the vehicle trim panel and retain the doghouse structure in the assembled position.

16. The method of claim 15, further comprising installing a fastener into the cap.

17. The method of claim 16, further comprising installing the fastener into a body opening in the vehicle to secure the vehicle trim assembly to the vehicle.

18. The method of claim 15, wherein at least one rib of the plurality of the plurality of ribs engage with at least one base slot defined in the base.

19. The method of claim 15, wherein at least one rib of the plurality of ribs engage with a lateral end of the base.

20. The method of claim 19, wherein at least two ribs of the plurality of ribs engage opposing lateral ends of the base.
